(19) United States
(12) Patent Application Publication
(10) Pub. No.: US 2013/0062236 A1
(43) Pub. Date: Mar. 14, 2013

(54) TOOLBOX

(71) Applicant: Yoshiki Nakazawa, Shizuoka-ken (JP)

(72) Inventor: Yoshiki Nakazawa, Shizuoka-ken (JP)

(73) Assignee: SUZUKI MOTOR CORPORATION, Shizuoka-ken (JP)

(21) Appl. No.: 13/699,055

(22) PCT Filed: Mar. 7, 2011
(86) PCT No.: PCT/JP2011/055197

§ 371 Date: Nov. 20, 2012

(30) Foreign Application Priority Data
May 29, 2010 (JP) 2010-123622

(51) Int. Cl. B60R 11/06; B65D 51/26; B65D 45/02; B65D 43/02

(52) U.S. Cl. 206/372; 206/349

(57) ABSTRACT

A toolbox includes a box body 11 that stores a tool, and a cover 12 that covers an opening portion 11K of the box body 11, wherein cutouts 23 and 24 that are opened toward an outer side of the above opening portion 11K are formed in side walls 22 of the box body 11, fitting convex portions 25 and 26 that are fitted to the cutouts 23 and 24 are provided on the cover 12, the cover 12 is internally fitted to the opening portion 11K of the box body 11, and a closed section is formed in a state in which the cover 12 is mounted to the box body 11.

### TECHNICAL FIELD

The present invention relates to a toolbox.

### BACKGROUND ART

As a toolbox that stores a tool required for tire replacement or the like and is mounted on a vehicle, there has conventionally been proposed a structure in which a plurality of fitting concave portions shaped along respective tools are dispersedly arranged on one surface side of a plate-like tool pad, and a thin plate-like opening-closing lid that covers the one surface side of the tool pad is provided, a plurality of tools are separately fitted to the plurality of fitting concave portions, and the above opening-closing lid covers the above fitting concave portions to store the respective tools as disclosed in, for example, Patent Literature 1.

### CITATION LIST

### Patent Literature

[Patent Literature 1] Japanese Utility Model Laid-Open No. 57-31249

### SUMMARY OF INVENTION

### Technical Problem

In the above conventional structure, since the plurality of fitting concave portions shaped along the respective tools are dispersedly arranged on the one surface side of the one plate-like tool pad, it is necessary to make the tool pad to be substantially thick-walled as disclosed in FIG. 2 in Patent Literature 1 so as to ensure the rigidity of the tool pad, so that the tool pad increases in size.

An object of the present invention is to provide a toolbox which can be reduced in size.

### Solution to Problem

The present invention comprises the following:

a box body for storing a tool, and

a cover for covering an opening portion of the above box body,

wherein a cutout that is opened toward an outer side of the above opening portion is formed in a side wall of the above box body,

wherein a fitting convex portion that is fitted to the above cutout is provided on the above cover,

wherein the above cover is internally fitted to the opening portion of the above box body, and

wherein a closed section is formed in a state in which the above cover is mounted to the above box body.

With the above configuration, since the fitting convex portion of the cover is fitted to the cutout of the box body and the cover is internally fitted to the opening portion of the box body, the cover can be firmly fixed to the box body. Since the closed section is formed in a state in which the cover is mounted to the box body, the rigidity and strength of a toolbox can be ensured even when the toolbox is set to be thin-walled, so that the toolbox can be reduced in size, weight, and space.

In the present invention, when

a first convex portion that presses the tool in the above box body in a state in which the above cover is mounted to the above box body is provided projecting on a reverse side of the above cover, the tool can be reliably fixed to the box body, and movement of the tool in the box body can be prevented.

In the present invention, when the above first convex portion is located between adjacent tools in the above box body to prevent interference between the above adjacent tools, generation of sound due to the interference between the adjacent tools can be prevented.

In the present invention, when a band that tightens and fixes the above cover to the above box body is provided, the cover can be reliably fixed to the box body.

In the present invention, when the above cover is tightened to the above box body by the above band to hold and fix the tool in the above box body between the above cover and a bottom wall of the above box body, the tool can be more reliably fixed to the box body by a tightening force of the band, and the movement of the tool in the box body can be prevented.

In the present invention, the following advantage can be obtained when the above tool is a pantograph-type jack, and a second convex portion in pressure-contact with a jack ring through which a shaft of the above jack is inserted in a state in which the above jack is held between the above cover and the bottom wall of the above box body is provided projecting on the bottom wall of the above box body or the above cover.

When the above second convex portion is brought into abutment against the jack ring, a force in an opposite direction to a pressing force from the cover is applied to the jack ring. Accordingly, the jack ring is fixed to the box body, and the shaft of the jack is also pressed by the jack ring and fixed to the box body, so that generation of so-called clattering sounds can be prevented and unpleasant sound generation can be prevented since movement of the jack ring and the shaft as a noise generation source of the jack is inhibited.

### Advantageous Effects of Invention

The present invention can provide the toolbox which can be reduced in size, weight, and dimensions.

### BRIEF DESCRIPTION OF DRAWINGS

FIG. 1 is a perspective view of a vehicle body rear portion structure in a state in which a toolbox is stored in a toolbox storage portion.

FIG. 2 is a perspective view of the vehicle body rear portion structure in a state in which the toolbox is removed from the toolbox storage portion.

FIG. 3 is a view of a box body of the toolbox as viewed from an opening side of the toolbox.

FIG. 4(a) is a view of the toolbox as viewed from the opening side; FIG. 4(b) is a side view of the toolbox; and FIG. 4(c) is a side view of the box body of the toolbox.

FIG. 5 is a sectional view along A-A of FIG. 4(a).

FIG. 6 is a sectional view along B-B of FIG. 4(a).

FIG. 7 is a sectional view along C-C of FIG. 4(a) (also illustrating a seatback or the like).

FIG. 8 is a front view (a view as viewed from a vehicle front side) of a rear seat.

FIG. 9 is a sectional view along G-G of FIG. 8.

FIG. 10 is a perspective view of a cover.

FIG. 11 is a view of the toolbox tightened and fixed by a band as viewed from the opening side of the toolbox (not illustrating a tool).

### DESCRIPTION OF EMBODIMENTS

In the following, an embodiment of the present invention will be described based on the drawings.

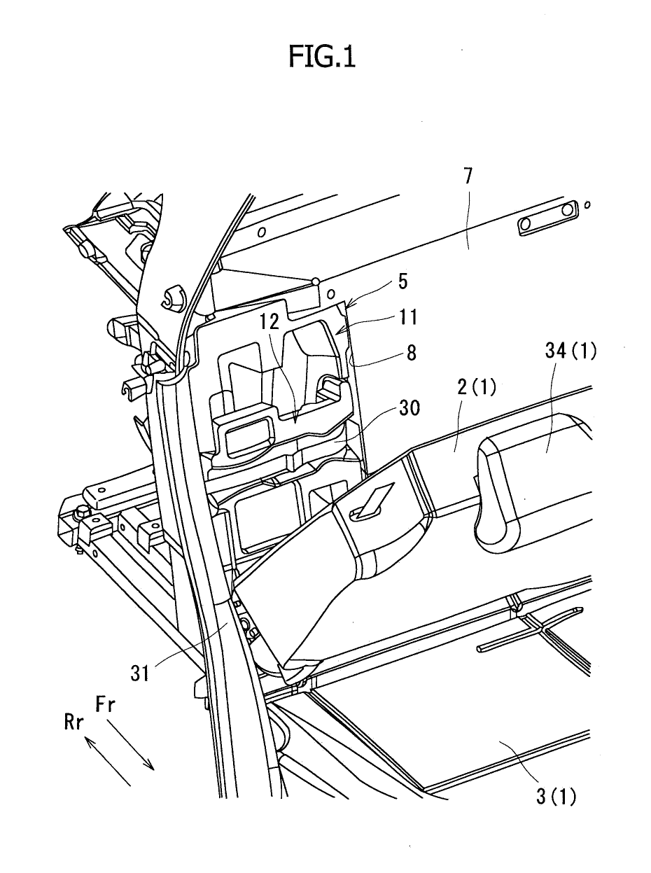

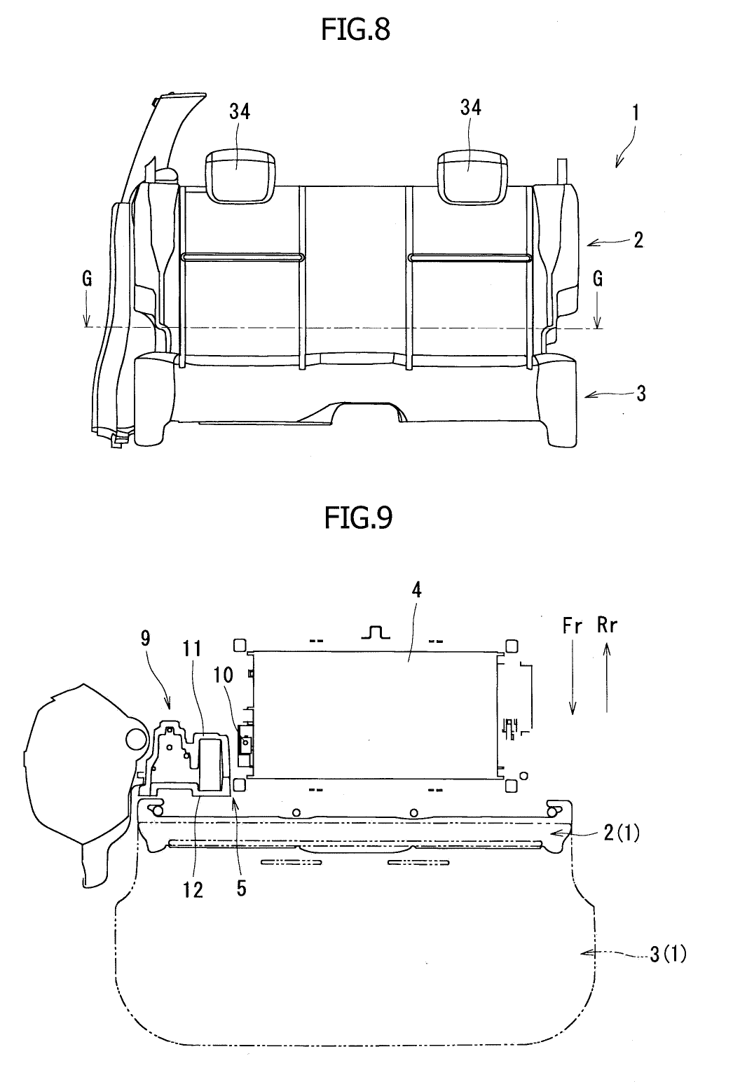

As shown in FIGS. 1, 2, 8, and 9, a large battery 4 (an electric battery) and a toolbox storage portion 5 are provided in a laterally arranged state on a reverse side (a vehicle rear side Rr) of a seatback 2 of a rear seat 1 to constitute a vehicle body rear portion structure of an electric car. The battery 4 occupies a large portion of a rear portion trunk on the reverse side of the seatback 2, and the toolbox storage portion 5 is formed smaller than the battery 4 on one end portion side (a right end portion side) in a width direction of the rear portion trunk.

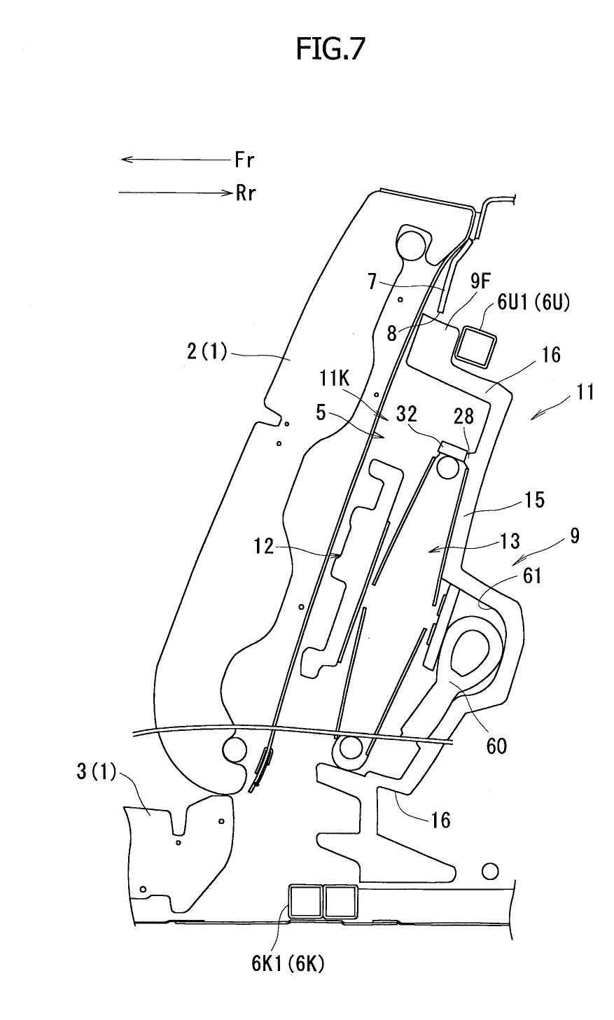

The above rear seat 1 is composed of a seat cushion 3, the seatback 2 that is swingable about a lateral axis on a lower side with respect to the seat cushion 3, and a headrest 34. A right and left pair of vertical frames 31 are vertically provided on both sides of the seatback 2. Also, an upper-side lateral frame 6U (see FIG. 7) is suspended between upper end portions of the right and left pair of vertical frames 31, and a lower-side lateral frame 6K is suspended between lower end portions of the right and left pair of vertical frames 31. A vertical wall 7 that covers the battery 4 from a vehicle front side Fr is suspended between the right and left pair of vertical frames 31 and the upper and lower lateral frames 6U and 6K.

The upper-side lateral frame 6U and the lower-side lateral frame 6K described above are formed in a square pipe shape, and the right and left pair of vertical frames 31, the upper-side lateral frame 6U, and the lower-side lateral frame 6K constitute a battery bracket.

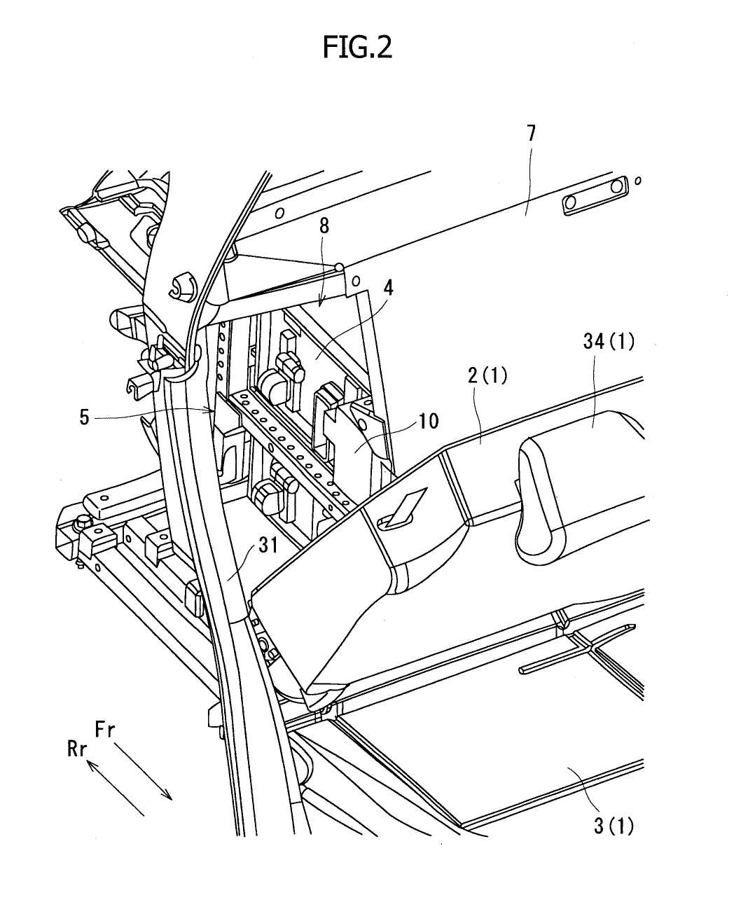

As shown in FIGS. 2 and 7, the above toolbox storage portion 5 is composed of a vertically-long square hole 8 formed in one end portion in a width direction of the vertical wall 7, an upper-side lateral frame portion 6U1 located on an upper end portion side of the square hole 8, and a lower-side lateral frame portion 6K1 located on a lower end portion side of the square hole 8. A toolbox 9 is stored in the toolbox storage portion 5 such that a longitudinal direction of the toolbox 9 is aligned with a vertical direction (more specifically, such that an upper side is located toward the vehicle rear side Rr).

The above toolbox 9 is loosely fitted to the square hole 8, a thick-walled flange portion 9F that projects upward from an upper end portion of the toolbox 9 is received and supported by the upper-side lateral frame portion 6U1 from the vehicle rear side Rr, and a lower end portion of the toolbox 9 is placed on the lower-side lateral frame portion 6K1. The toolbox 9 is stored in the toolbox storage portion 5 so as to be removable toward the vehicle front side Fr.

When the seatback 2 is tilted forward about the above lateral axis by unlocking a locking mechanism provided in the seatback 2, the toolbox 9 stored in the toolbox storage portion 5 is exposed, and when the toolbox 9 is removed toward the vehicle front side Fr from the toolbox storage portion 5, an emergency stop switch 10 of the battery 4 is exposed so as to be operable.

The seatback 2 in the above forward tilted state further swings toward the vehicle front side Fr from an inclined state shown in FIG. 1, and is thereby laid on the seat cushion 3. Accordingly, the toolbox 9 is largely exposed, and the toolbox 9 can be easily removed.

The above emergency stop switch 10 is a switch for stopping the battery 4 in an emergency, and is not required in normal use of automobiles. The switch is thus arranged on a back side of the toolbox 9 so as not to be unintentionally operated. However, it is necessary to enable access to the emergency stop switch 10 without using a special tool in an emergency. Thus, as described above, the emergency stop switch 10 of the battery 4 is configured such that the switch is exposed so as to be operable when the toolbox 9 is removed toward the vehicle front side Fr from the toolbox storage portion 5.

### [Structure of the Toolbox 9]

The above toolbox 9 is composed of a box body 11 that stores a tool, and a cover 12 that covers an opening of the box body 11. The box body 11 and the cover 12 are formed of a lightweight foamed resin material having excellent moldability and heat insulation properties. When the seatback 2 is tilted forward, the cover 12 is operable to be removed from the box body 11.

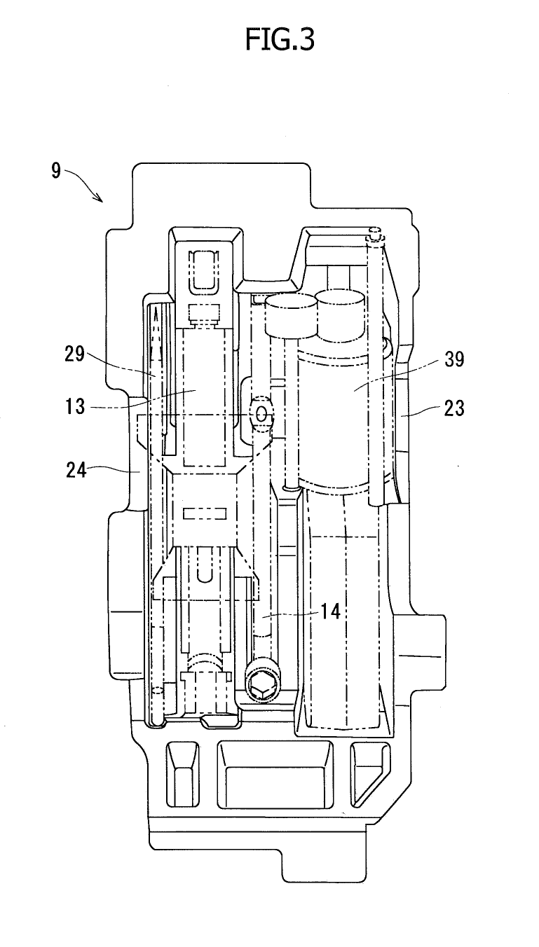

The tool is stored in a position along the vertical direction in the box body 11 in a state in which the toolbox 9 is stored in the toolbox storage portion 5 (see FIGS. 1, 3, and 7). As indicated by an alternating long dash and two short dashes line in FIG. 3, the tool stored in the box body 11 in the present embodiment includes tools for tire replacement such as a jack handle 29, a pantograph-type jack 13, a wheel wrench 14, and a flat tire repair kit 39.

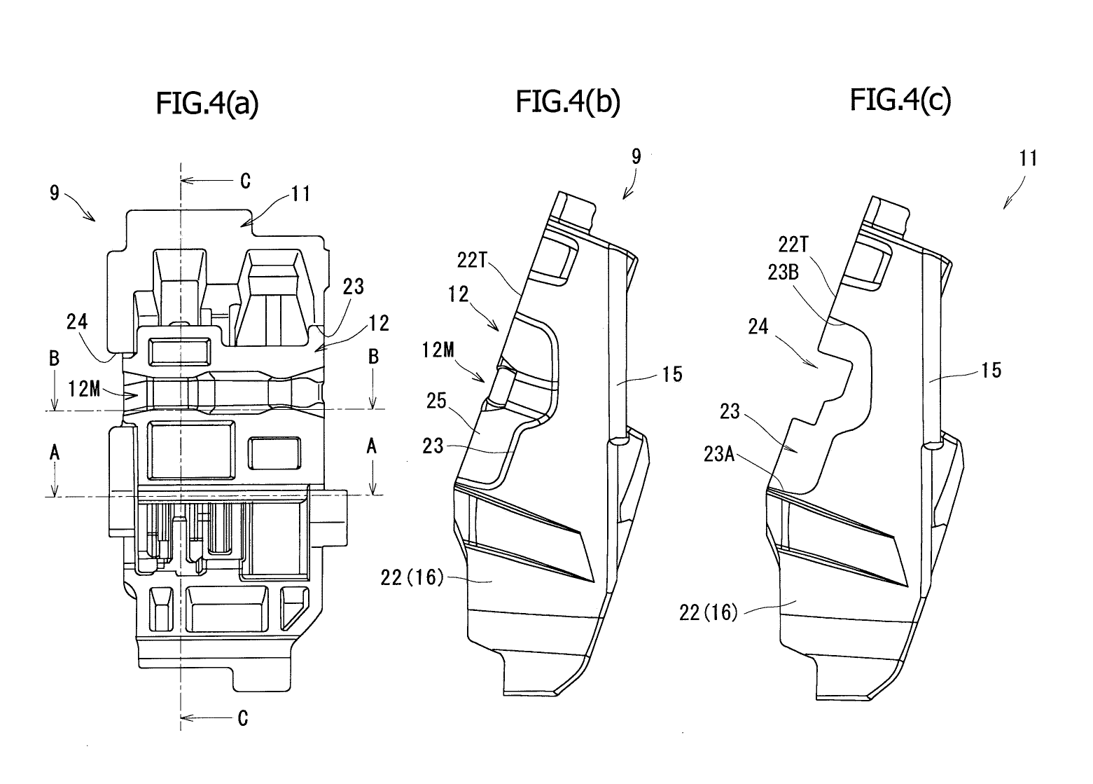

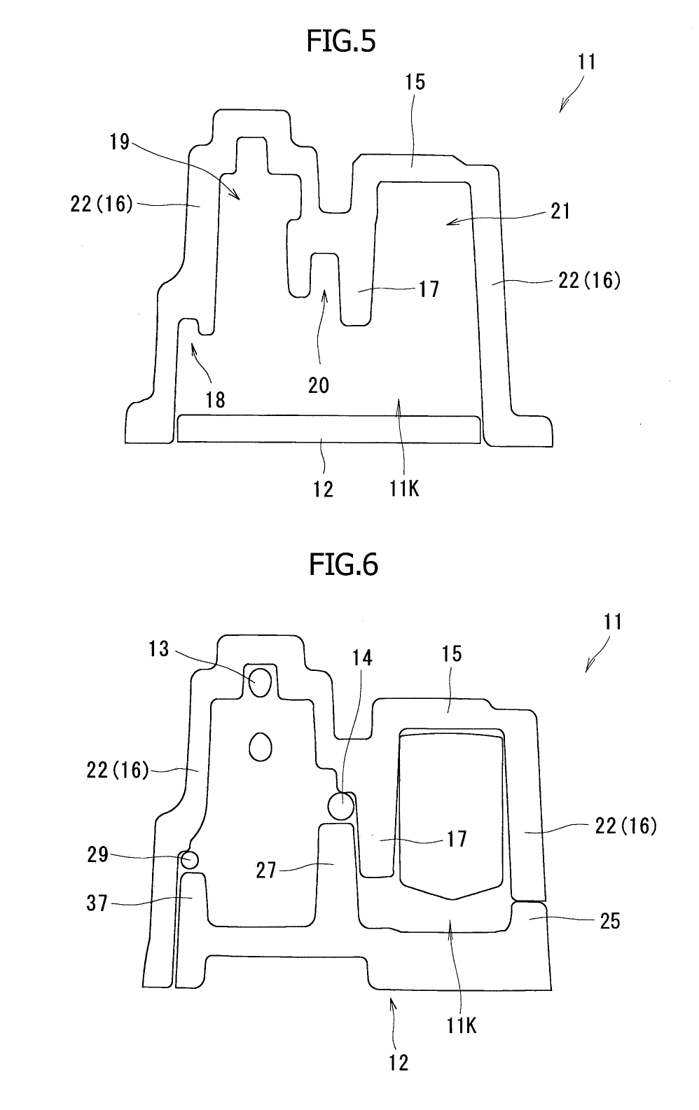

As shown in FIGS. 4(a) to 4(c), 5, and 6, the box body 11 includes a bottom wall 15 (see FIG. 7) having a rectangular shape as viewed from an opening portion 11K (see FIGS. 5 to 7) side of the box body 11, a peripheral wall 16 having a rectangular shape in section that rises from a peripheral portion of the bottom wall 15, and a partition wall 17 that partitions storage portions 18, 19, 20, and 21 for the respective tools.

Since the long tools such as the jack 13 and the wheel wrench 14 are stored in the box body 11, the respective storage portions for the respective tools are formed in a rectangular shape along a longitudinal direction of the box body 11 and arranged in a width direction of the box body 11. That is, as shown in FIG. 5, the jack handle storage portion 18, the jack storage portion 19, the wheel wrench storage portion 20, and the flat tire repair kit storage portion 21 are respectively formed sequentially from one end portion side in the width direction.

As shown in FIG. 4(c), top surfaces 22T of side walls 22 in an upper half portion that is located on the upper side in the above storage state out of side walls 22 constituting the above peripheral wall 16 are inclined such that the height dimension decreases toward the upper side in a state in which the toolbox 9 is stored in the toolbox storage portion 5. Accordingly, interference between a reverse surface (see FIG. 7) of the seatback 2 inclined such that an upper end portion side is located toward the vehicle rear side Rr, and the top surfaces 22T of the side walls 22 of the toolbox 9 can be avoided.

As shown in FIGS. 4(a) and 4(c), cutouts 23 and 24 that are opened toward an outer side (an opposite side to the bottom wall 15) of the opening portion 11K (see FIGS. 5 to 7) are formed in longitudinal intermediate portions of the both side walls 22 of the above box body 11. One of the cutouts 23 located on a vehicle-width inner side is formed longer in the longitudinal direction of the box body 11 and deeper than the other cutout 24 located on a vehicle-width outer side.

As shown in FIG. 4(c), the above one of the cutouts 23 is formed long in the longitudinal direction of the top surface 22T of the side wall 22, a cutout portion 23A in a lower half portion that is located on the lower side in a state in which the toolbox 9 is stored in the toolbox storage portion 5 is formed in a rectangular shape that is long in the longitudinal direction of the above top surface 22T, and a cutout portion 23B in the upper half portion is formed in a deeper shape than the cutout portion 23A in the above lower half portion, so that the both cutout portions are smoothly continuous to each other.

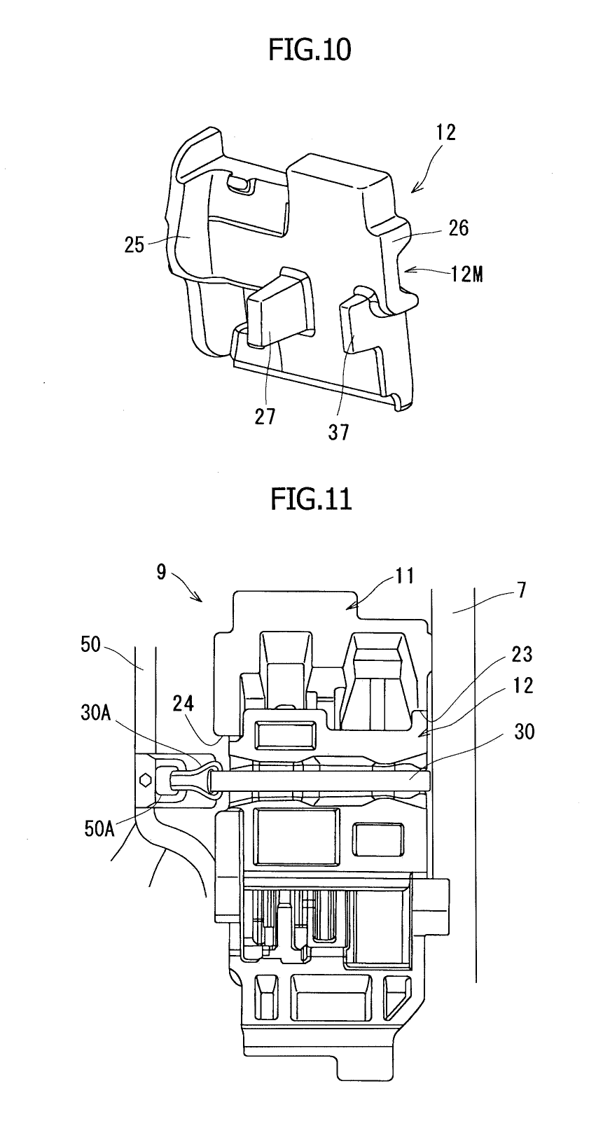

As shown in FIG. 10, a right and left pair of fitting convex portions 25 and 26 fitted to the above cutouts 23 and 24 are provided on the cover 12. The above right and left pair of fitting convex portions 25 and 26 are separately fitted to the right and left pair of cutouts 23 and 24, so that the cover 12 is mounted to top portions of the both side walls 22 in the longitudinal intermediate portion of the box body 11. The fitting convex portions 25 and 26 are formed in a shape corresponding to the cutouts 23 and 24 of the box body 11, and are fitted to the above cutouts 23 and 24 to constitute a portion of the side walls of the toolbox 9.

The cover 12 is set to be shorter than the length of the box body 11, and both longitudinal end portions (both vertical end portions) of the respective tools are exposed in a state in which the cover 12 is mounted to the box body 11. Accordingly, it is possible to check whether or not the respective tools are stored, and the cover 12 can be reduced in size, weight, and material cost.

As shown in FIGS. 5 and 6, both end portions in a width direction of the above cover 12 are fitted (internally fitted) between the both side walls 22 of the box body 11 such that a closed section is formed in the toolbox 9 in a state in which the cover 12 where the fitting convex portions 25 and 26 are fitted to the above cutouts 23 and 24 is mounted to the box body 11.

As described above, the fitting convex portions 25 and 26 of the cover 12 are fitted to the cutouts 23 and 24 of the box body 11, and the cover 12 is fitted between the both side walls 22 of the box body 11, so that the cover 12 can be firmly fixed to the box body 11. Since the closed section is formed in a state in which the cover 12 is mounted to the box body 11, the rigidity and strength of the toolbox 9 can be ensured even when the toolbox 9 is set to be thin-walled, so that the toolbox 9 can be reduced in size, weight, and dimensions.

As shown in FIG. 10, a right and left pair of first convex portions 27 and 37 having a rectangular shape in section are provided projecting on a reverse side of an end portion in the width direction of the cover 12, and a reverse side of a width center portion such that a longitudinal intermediate portion of the jack handle 29 in the jack handle storage portion 18 of the box body 11, and a longitudinal intermediate portion of the wheel wrench 14 in the wheel wrench storage portion 20 are separately pressed by the above right and left pair of first convex portions 27 and 37 from the vehicle front side Fr as shown in FIGS. 5 and 6 in a state in which the cover 12 is mounted to the box body 11.

The above first convex portions 27 and 37 are located between the adjacent tools in the box body 11 to prevent interference between the adjacent tools and thereby prevent generation of sounds due to the interference.

Accordingly, the tools can be reliably fixed to the box body 11, and movement of the tools in the box body 11 can be prevented. That is, even when such a layout that the jack handle 29 and the wheel wrench 14 three-dimensionally cross the jack 13 (see FIG. 3) is employed, the jack 13 and the jack handle 29, and the jack 13 and the wheel wrench 14 can be prevented from colliding with each other, and the generation of sounds can be thereby prevented.

As shown in FIGS. 1 and 11, a band 30 that tightens and fixes the above cover 12 to the above box body 11 and tightens and fixes the cover 12 and the box body 11 to a vehicle body is provided. One end portion of the band 30 is fixed to the above vertical wall 7. A hook 30A is provided in the other end portion of the band 30 such that the hook 30A is engaged with an engagement portion 50A provided in a quarter panel 50. A groove 12M (see FIG. 4(a)) for winding the band in the width direction of the cover 12 is formed in a front-side surface of the cover 12.

The cover 12 is tightened and fixed to the box body 11, and the cover 12 and the box body 11 are tightened and fixed to the vehicle body by the above band 30, so that generation of abnormal sounds due to vibrations of the tools in the toolbox 9 during running can be prevented.

Also, as described above, the jack 13 (or another tool) in the box body 11 is held and fixed between the cover 12 and the bottom wall 15 of the box body 11 by tightening the cover 12 to the above box body 11 by the band 30. Accordingly, the jack 13 can be more reliably fixed to the box body 11 by increasing a holding force on the jack 13.

As shown in FIG. 7, a second convex portion 28 in pressure-contact with a jack ring 32 through which a shaft of the jack 13 is inserted in a state in which the jack 13 is held between the cover 12 and the bottom wall 15 of the box body 11 is provided projecting on the bottom wall 15 of the box body 11. The second convex portion 28 in pressure-contact with the above jack ring 32 may be also provided projecting on a reverse side of the cover 12.

The jack ring 32 is a member adjacent to a U-shaped portion to be engaged with which an engagement portion of the jack handle 29 is engaged. When the above portion to be engaged is rotationally operated by an operator via the jack handle 29, the jack 13 extends and contracts with the shaft of the jack 13 rotating about the axis of the shaft.

In the jack 13 having the structure as described above, when the above second convex portion 28 is brought into abutment against the jack ring 32, a force in an opposite direction to a pressing force from the cover 12 is applied to the jack ring 32. Accordingly, the jack ring 32 is fixed to the box body 11, and the shaft of the jack 13 is also pressed by the jack ring 32 and fixed to the box body 11, so that generation of so-called clattering sounds can be prevented and unpleasant sound generation can be prevented since movement of the jack ring 32 and the shaft as a noise generation source of the jack 13 is inhibited.

Normally, when tools are arranged on a board in an upper portion of a spare tire in a trunk, the plurality of tools are mostly arranged horizontally along a trunk space so as to be stored as flatly as possible, and thus, a large area is required. Meanwhile, with the aforementioned configuration in the present invention, the toolbox 9 is arranged in the vertically-placed position that is vertically long along the reverse surface of the seatback 2, so that the long tools such as the jack 13 and the wheel wrench 14 can be three-dimensionally arranged so as to be displaced in a vehicle front-back direction as shown in FIG. 3 and FIG. 7. Reference numeral 60 in FIG. 7 denotes a towing hook bolt, which is stored in a hook bolt storage portion 61 on the bottom wall 15 side from the jack 13. Accordingly, the toolbox 9 can be further reduced in size, dimensions, and material cost.

### [Removal of the Tools]

In the aforementioned structure, the tools are removed from the toolbox 9 in the following procedure.
(1) The seatback 2 is tilted forward by unlocking the locking mechanism of the seatback 2.
(2) The above tightening band 30 is released from the vehicle front side Fr (the rear seat 1 side).
(3) The cover 12 is opened and removed from the box body 11, and the tools are removed from the box body 11.

As described above, the tools can be removed from the box body 11 without removing the box body 11 from the toolbox storage portion 5. Also, since the toolbox 9 is stored in the toolbox storage portion 5 in such an inclined position that the upper side is located toward the vehicle rear side Rr, a passenger can remove the cover 12 of the toolbox 9 from the front upper side and thereby easily removes the tools. When the tools are stored in the respective storage portions of the toolbox 9, the tools are stored in a procedure opposite to the above procedure.

### [Operation of the Emergency Stop Switch 10]

The emergency stop switch 10 of the battery 4 is accessed in an emergency in the following procedure.
(1) The seatback 2 is tilted forward by unlocking the locking mechanism of the seatback 2.
(2) The above tightening band 30 is released from the vehicle front side Fr (the rear seat 1 side).
(3) The toolbox 9 is removed from the toolbox storage portion 5. Accordingly, the emergency stop switch 10 is exposed through the opening (the square hole 8) of the vertical wall 7, and the emergency stop switch 10 becomes operable.

It is possible to cause an operator to perform a step of tilting the seatback 2 forward, a step of releasing the tightening band 30, and a step of removing the toolbox 9 from the toolbox storage portion 5 before the emergency stop switch 10 of the battery 4 is exposed so as to operable.

Accordingly, the access to the emergency stop switch 10 is enabled only in a case of operation based on a clear intention of an operator, and unintentional operation of the emergency stop switch 10 can be more reliably prevented.

Since the emergency stop switch 10 is covered up by the toolbox 9 as means to cause an operator to perform the above steps, a special cover 12 for covering up the emergency stop switch 10 does not need to be provided, so that the number of parts can be reduced, the structure can be simplified, and the manufacturing cost can be lowered.

Moreover, since the box body 11 and the cover 12 of the toolbox 9 are formed of the foamed resin material having heat insulation properties, heat transfer from the opening (the square hole 8) of the vertical wall 7 to the seatback 2 due to heat generation of the battery 4 can be prevented. As a result, a temperature rise in the seatback 2 can be suppressed, and a passenger can be prevented from feeling uncomfortable.

With the above configuration, since the battery 4 and the toolbox storage portion 5 are provided in a laterally arranged state on the reverse side of the above seatback 2, the toolbox 9 can be arranged on the rear side of the seatback 2 even in a vehicle body rear portion structure of a vehicle with a short front-back length in which the large battery 4 needs to be mounted.

### Another Embodiment

Although not shown in the drawings, the present invention may be also applied to a following structure.

That is, a back surface of the above cover 12 is attached to a reverse surface of a luggage carpet, and the box body 11 is attached to a concave portion formed in a floor panel with the above opening portion 11K being opened toward the upper side. A force for pressing the box body 11 or the tools is thereby generated under the weight of the carpet itself. Accordingly, the toolbox 9 requires a smaller space and can prevent noise, so that a larger loading capacity can be ensured for a luggage compartment or a trunk compartment.

### REFERENCE SIGNS LIST

11 Box body
11K Opening portion
12 Cover
13 Tool (jack)
14 Tool (wheel wrench)
15 Bottom wall (bottom wall of the box body)
22 Side wall
23, 24 Cutout
25, 26 Fitting convex portion
27, 37 First convex portion
28 Second convex portion
39 Tool (jack handle)
30 Band
32 Jack ring
39 Tool (flat tire repair kit)

1. A toolbox comprising a box body for storing a tool, and a cover for covering an opening portion of the box body,
wherein a cutout that is opened toward an outer side of the opening portion is formed in a side wall of the box body,
wherein a fitting convex portion that is fitted to the cutout is provided on the cover,
wherein the cover is internally fitted to the opening portion of the box body, and
wherein a closed section is formed in a state in which the cover is mounted to the box body.

2. The toolbox according to claim 1, wherein a first convex portion that presses the tool in the box body in a state in which the cover is mounted to the box body is provided projecting on a reverse side of the cover.

3. The toolbox according to claim 2, wherein the first convex portion is located between adjacent tools in the box body to prevent interference between the adjacent tools.

4. The toolbox according to claim 1, wherein a band that tightens and fixes the cover to the box body is provided.

5. The toolbox according to claim 4, wherein the cover is tightened to the box body by the band to hold and fix the tool in the box body between the cover and a bottom wall of the box body.

6. The toolbox according to claim 5,
wherein the tool is a pantograph-type jack, and
wherein a second convex portion in pressure-contact with a jack ring through which a shaft of the above jack is inserted in a state in which the above jack is held between the cover and the bottom wall of the box body is provided projecting on the bottom wall of the box body or the cover.

7. The toolbox according to claim 2, wherein a band that tightens and fixes the cover to the box body is provided.

8. The toolbox according to claim 7, wherein the cover is tightened to the box body by the band to hold and fix the tool in the box body between the cover and a bottom wall of the box body.

9. The toolbox according to claim 8,
wherein the tool is a pantograph-type jack, and
wherein a second convex portion in pressure-contact with a jack ring through which a shaft of the above jack is inserted in a state in which the above jack is held between the cover and the bottom wall of the box body is provided projecting on the bottom wall of the box body or the cover.

10. The toolbox according to claim 3, wherein a band that tightens and fixes the cover to the box body is provided.

11. The toolbox according to claim 10, wherein the cover is tightened to the box body by the band to hold and fix the tool in the box body between the cover and a bottom wall of the box body.

12. The toolbox according to claim 11,
wherein the tool is a pantograph-type jack, and
wherein a second convex portion in pressure-contact with a jack ring through which a shaft of the above jack is inserted in a state in which the above jack is held between the cover and the bottom wall of the box body is provided projecting on the bottom wall of the box body or the cover.
